(19) United States
(12) Patent Application Publication
(10) Pub. No.: US 2014/0198177 A1
(43) Pub. Date: Jul. 17, 2014

(54) REALTIME PHOTO RETOUCHING OF LIVE VIDEO

(71) Applicant: INTERNATIONAL BUSINESS MACHINES CORPORATION, Armonk, NY (US)

(72) Inventors: Marzia E. Castellani, Zagarola (IT); Roberto Ragusa, Lucera (IT)

(73) Assignee: INTERNATIONAL BUSINESS MACHINES CORPORATION, Armonk, NY (US)

(21) Appl. No.: 13/742,242

(22) Filed: Jan. 15, 2013

(51) Int. Cl. H04N 13/00

(52) U.S. Cl. CPC H04N 13/0007
USPC 348/43

(57) ABSTRACT

Provided are techniques for processing a subset of a plurality of video frames to produce a 3D model of a particular element within each frame of the subset; processing the plurality of video frames to identify a particular feature within the particular element in each frame of the plurality of frames in which the particular feature appears to produce a plurality of instances of the element, each instance of the plurality of instances associated with a corresponding frame of the plurality of frames; modifying each instance of the plurality of instances in accordance with use parameters and in conformity with the 3D model to generate a plurality of modified instances; and replacing each instance of the plurality of instances with a corresponding modified instance in the corresponding frame of the plurality of frames to produce a modified video file.

### FIELD OF DISCLOSURE

The claimed subject matter relates generally to image modification and, more specifically, to the dynamic retouching of live video images.

### BACKGROUND

Manipulation of digital pictures to make the images more appealing is well known in the advertising and entertainment fields. Human faces and bodies are commonly the targets of such “photo retouching” or simply “retouching.” While retouching was once done exclusively by specialized people, or “retouching artists,” the process has in recent years become automated and performed by computing devices. Such automated photo retouching may be a complement or replacement for traditional makeup, hair and lighting experts.

In computing systems, faces may he automatically detected, measured and modified according to specific “fitness” criteria such as, but not limited to rules on dimension and color. In the case of video images, multiple frames may need modification such that the changes remain consistent through successive frames in a particular sequence of frames.

### SUMMARY OF THE INVENTION

Provided are techniques for processing a subset of a plurality of video frames to produce a 3D model of a particular element within each frame of the subset; processing the plurality of video frames to identify a particular feature within the particular element in each frame of the plurality of frames in which the particular feature appears to produce a plurality of instances of the element, each instance of the plurality of instances associated with a corresponding frame of the plurality of frames; modifying each instance of the plurality of instances in accordance with user-defined parameters and in conformity with the 3D model to generate a plurality of modified instances; and replacing, each instance of the plurality of instances with a corresponding modified instance in the corresponding frame of the plurality of frames to produce a modified video file.

This summary is not intended as a comprehensive description of the claimed subject matter but, rather, is intended to provide a brief overview of some of the functionality associated therewith. Other systems, methods, functionality, features and advantages of the claimed subject matter will he or will become apparent to one with skill in the art upon examination of the following figures and detailed description.

### DESCRIPTION OF THE DRAWINGS

A better understanding of the claimed subject matter can be obtained when the following, detailed description of the disclosed embodiments is considered in conjunction with the following figures, in which:

FIG. 1 is a Video Capture and Editing Architecture (VCEA) on which the claimed subject matter may be implemented.

FIG. 2 is a block diagram of an Automatic Photograph Retouching System (APRS) that may implement the claimed subject matter.

FIG. 3 is an example of a flowchart of “Modify Video” process that may implement aspects of the claimed subject matter.

FIG. 4 is an example of a flowchart of “Model Frames” process that may implement aspects of the claimed subject matter.

FIG. 5 is one example of a video frame that may be analyzed and modified in accordance with the claimed subject matter.

FIG. 6 is a modified video frame, based upon the video frame first introduced in FIG. 5, after modification in accordance with the claimed subject matter.

### DETAILED DESCRIPTION

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may he any computer readable medium that is not a computer readable storage medium and that can communicate, propagate, or transport a program for use by or in connection with an instruction execution system, apparatus, or device.

Program code embodied on a computer readable medium may he transmitted using any appropriate medium, including but not limited to wireless, wireline, optical fiber cable. RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational actions to be performed on the computer, other programmable apparatus or other devices to produce a computer implemented process such that the instructions which execute on the computer or other programmable apparatus provide processes for implementing the functions/acts specified in the flowchart and/or block diagram block or blocks.

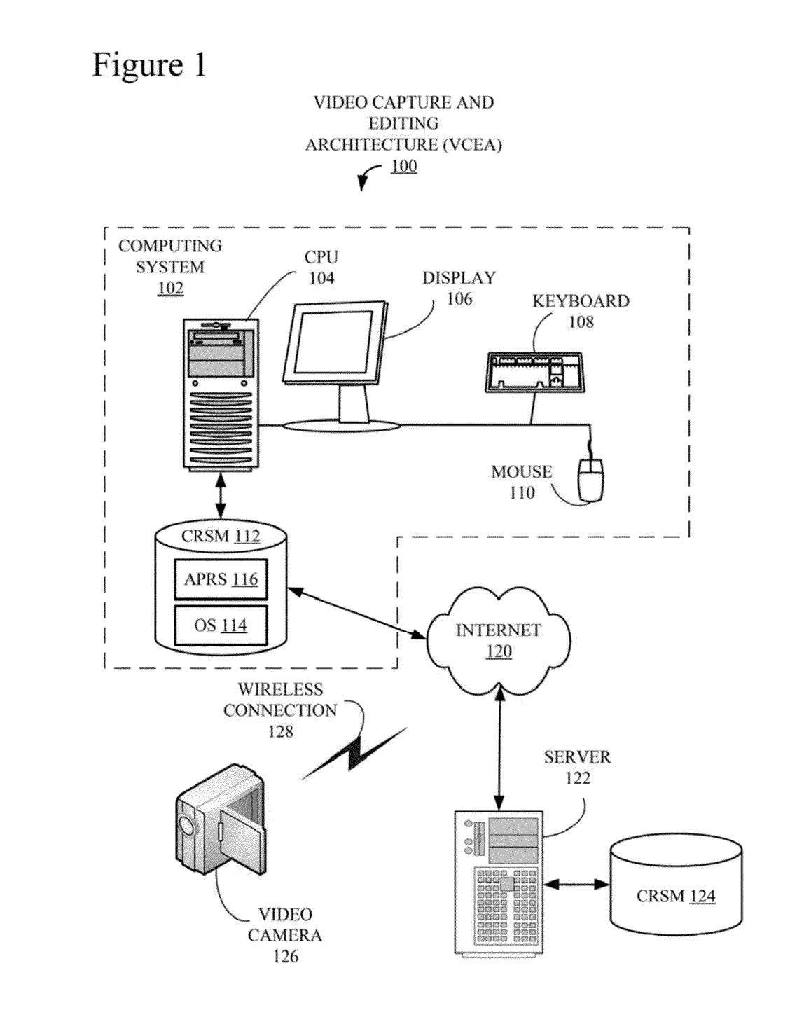

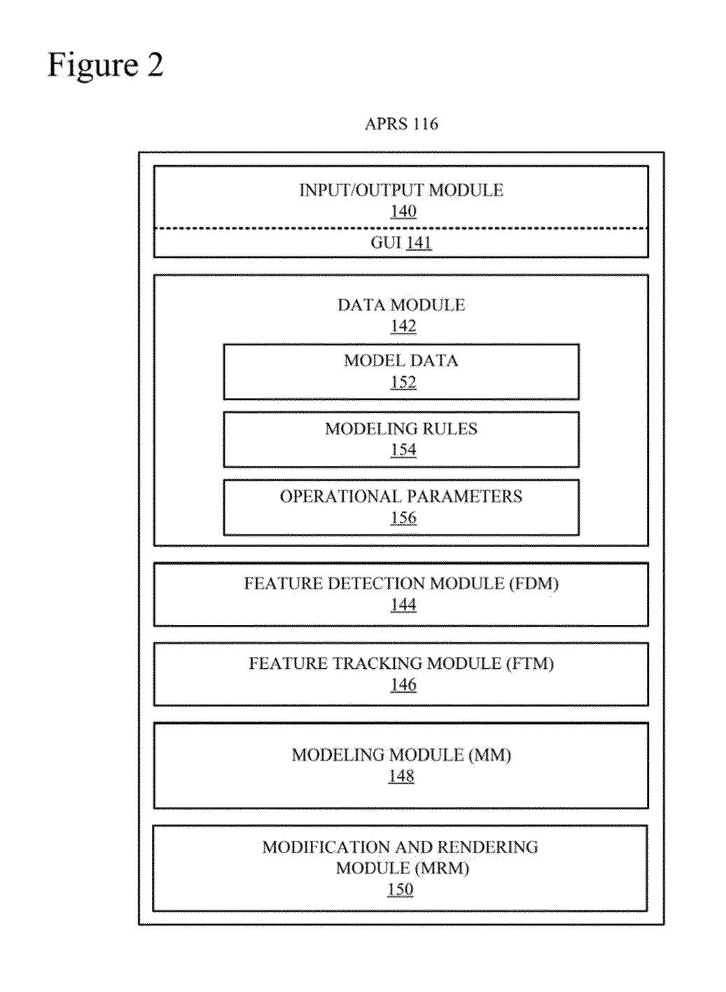

Turning now to the figures, FIG. 1 is a Video Capture and Editing Architecture (VCEA) 100 on which the claimed subject matter may be implemented. A computing system 102 includes a central processing unit (CPU) 104, coupled to a display 106, a keyboard 108 and a pointing device, or “mouse,” 110, which together facilitate human interaction with VCEA 100 and computing system 102. Also included in computing system 102 and attached to CPU 104 is a computer-readable storage medium (CRSM) 112, which may either he incorporated into client system 102 i.e. an internal device, or attached externally to CPU 104 by means of various, commonly available connection devices such as but not limited to, a universal serial bus (USB) port (not shown). CRSM 112 is illustrated storing an operating system (OS) 114 and an Automatic Photograph Retouching System (APRS) 116 that incorporates the claimed subject matter. APRS 116 is described in more detail below in conjunction with FIGS. 2-6.

In this example, computing system 102 and CPU 104 are connected to the Internet 120, which is also connected to a server computer, or simply “server,” 122. Although in this example, computing system 102 and server 122 are communicatively coupled via the Internet 120, they could also be coupled through any number of communication mediums such as, but not limited to, a local area network (LAN) (not shown). Coupled to server 122 is a CRSM 124. Typically, server 122 would also include a CPU, display, keyboard and mouse, like 104, 106, 108 and 110, but for the sake of simplicity they are not shown.

Also included in VCEA 100 is a video camera 126, which is illustrated with a wireless connection 128 to the Internet 120. Wireless connection 128 is used as one example of a means to transmit video files captured by video camera 126 to other devices such as computing system 100 and server 122. One with skill in the relevant arts will appreciate that they are many transmission devices such as, but not limited to, memory sticks and cables. Video camera 126 is used as an example of a device other than computing system 102 and server 122 that may also incorporate the disclosed technology as described below in conjunction with APRS 116. Other devices not illustrated that may incorporate the claimed subject matter, perhaps in conjunction with a built-in video recording device, include, but are not limited to, tablet computers and smart phones. Further, it should be noted there are many possible video capture and editing architectures and configurations, of which VCEA 100 is only one simple example. Further, the claimed subject matter does not necessarily have to he implemented upon devices that capture video as the disclosed technology is also applicable to devices that merely process video files captured by other devices.

FIG. 2 is a block diagram of APRS 16, first introduced in FIG. 1, in greater detail. APRS 116 includes an input/output (I/O) module 140, a data module 142, a feature detection module (FDM) 144, a feature tracking module (FTM) 146, a Modeling module 148 and a Modification and Rendering module (MRM) 150. For the sake of the following examples, APRS 116 is assumed to be stored in CRSM 112 (FIG. 1) and execute on one or more processors (not shown) of computing system 102 (FIG. 1). It should be understood that the claimed subject matter can be implemented in many types of computing systems and video capture and storage systems but for the sake of simplicity, is described only in terms of APRS 116 (FIG. 1) and computing system 102. For example, APRS 116 may be configured to be stored and executed on server 122 (FIG. 1) and video camera 126 (FIG. 1).

Further, the representation of APRS 116 in FIG. 2 is a logical model. In other words, components 140, 141, 142, 144, 146, 148 and 150 may be stored in the same or separates files and loaded and/or executed within architecture 100, computing system 102, server 122 or video camera 126 either as a single system or as separate processes interacting via any available inter process communication (UPC) techniques.

Input/Output (I/O) module 140 handles any communication APRS 116 has with other components of APRS 116 and computing system 102. Included in module 140 is a graphical user interface (GUI) 141. GUI 141 enables users of APRS 116 to interact with and to define the desired functionality of APRS 116.

Data module 142 is a data repository for information, including model and parameters, that APRS 116 requires during normal operation. Examples of the types of information stored in data module 142 include model data 152, modeling rules 154 and operational parameters 156. Model data 152 stores both 3D model templates and 3D models generated by APRS 116, sometimes based upon the templates. For example there might he various templates for rendering a human head with a model for a specific head detected within a video file based upon a modification of a similar, selected template. Throughout the Specification, the primary example will be the modeling and rendering of a human head and facial features although it should he understood that the disclosed techniques are equally applicable to other video elements.

Modeling rules 154 stores various algorithms for extrapolating data with respect to models stored in model data 152. In addition to various geometric rules, addition rules might include, but are not limited to, the ratios of distances between facial features, rules for correction due to the angle of and distance to a facial feature such as eyes, nose and mouth. Addition rules may apply to a deformation of a 3D mesh corresponding to a model, e.g., plastic deformation, or to the color of individual pixels depending upon lighting, angle and other criteria, e.g. makeup and skin polishing. Operation parameters 156 stores user set parameters for controlling APRS 116. Examples include, but are not limited to, resolution of changes or input, e.g. pixels/inch, a number of frames to use for establishing as 3D mesh and an indication of specific algorithms for procedures for addressing missing pixels and feature-removal.

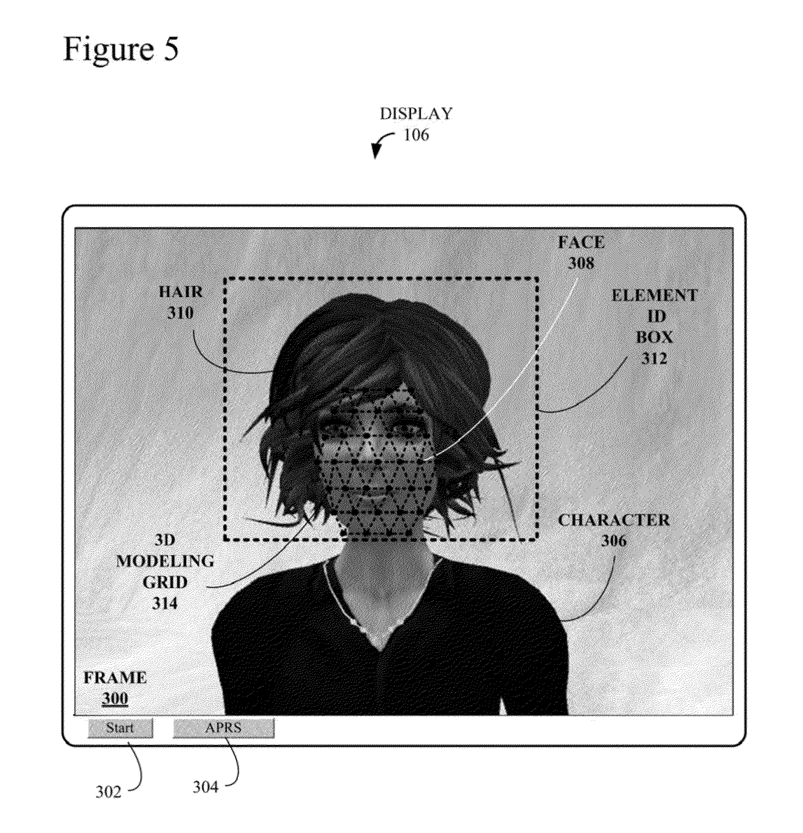

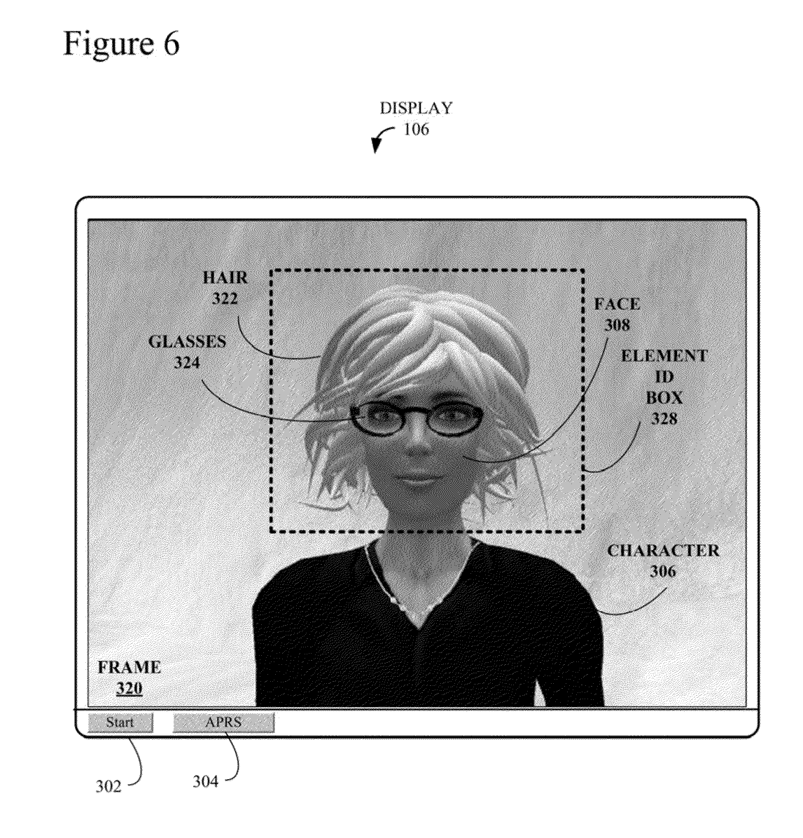

FDM 144 processes images to detect specific, defined features within the images. For example, FDM 144 may be directed to detect and store data relating to the presence of faces in the images of a video tile (see 310, FIGS. 5 and 6). Other types of features that may be detected for processing include, but are not limited to, apparel, vehicles and architectural elements.

FTM 146 generates a frame by frame correlation of features detected by FDM 144. MM 148 uses the data from FDM 144 and FTM 146 to generate a 3D model of the identified and tracked feature(s) (see 330, FIG. 6). Although as model might be extrapolated from a single video frame based upon assumption about the particular feature, a more accurate model may be obtained from addition images that show different perspectives. The specific number of images employed to generate a model may be defined by a user (see 156). As explained above, generated models are stored in models 152.

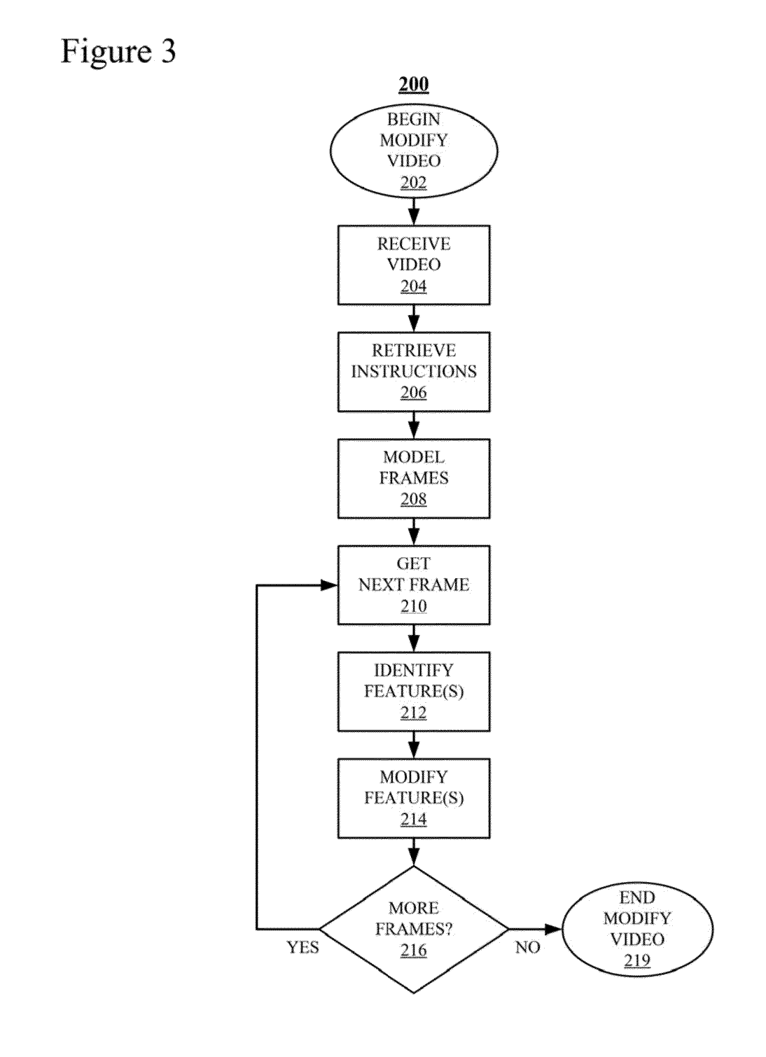

MRM 150 modifies features identified by FEW 144 and tracked by FTM 146 in accordance with modeling rules 154, operational parameters 156 and corresponding models 152. Components 142, 144, 146, 148, 150, 152, 154 and 156 are described in more detail below in conjunction with FIGS. 3-6.

FIG. 3 is an example of a flowchart of “Modify Video” process 200 that may implement aspects of the claimed subject matter. In this example, process 200 is associated with logic stored in conjunction with APRS 116 on CRSM 112 (FIG. 1) and executed on one or more processors (not shown) of CPU 104 of computing system 102. It should be understood that computing system 192 is only one example of a device or devices that may implement the claimed subject matter.

Process 200 starts in a “Begin Modify Video” block 202 and proceeds immediately to a “Receive Video” block 204. During processing associated with block 204, a video file is received for processing. Although described with respect to batch processing of a video file, it should be understood that aspects of the disclosed technology may also be processed frame by frame, i.e. serially. During processing associated with a “Receive Instructions” block 206, the particular modifications and operational parameters 156 (FIG. 2) that are to he applied to the video file received during processing associated with block 204 are retrieved. Such instructions may be received from a hatch file corresponding to the particular video file or collected interactively from a user via GUI 141 (FIG. 2).

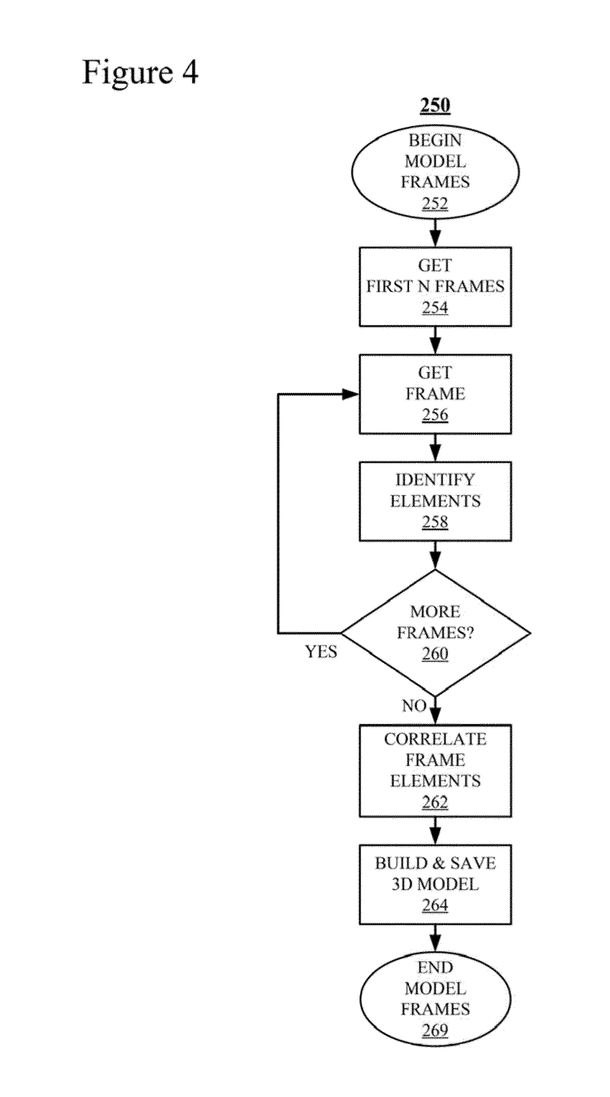

During processing associated with a “Model Frames” 208, a particular feature or features identified in the instructions received during processing associated with block 206 are identified (see FDM 144, FIG. 2), tracked (see FTM 146, FIG. 2) and modeled (see MM 148, FIG. 2). As explained above in conjunction with FIG. 2, a specific number of images employed in the modeling process may be defined with an operational parameter. Model Frames block 208 is described in more detail below in conjunction with a Model Frames process 250 of FIG. 4.

During processing associated with a “Get Next Frame” block 210, the next frame for processing is identified. Typically, during the first time through block 210, the first frame that includes the feature targeted for modification is the next frame. During processing associated with an “Identify Feature(s)” block 212, the particular feature or features targeted for modification are identified in the frame retrieved during processing associated with block 210. During processing associated with a “modify Feature(s)” block 214, the feature or features identified during processing associated with block 212 are modified in accordance with the instructions received during processing associated with block 206. Once modified, the frame is saved in either the original tile or a modified video file.

During processing associated with a “More Frames?” block 216, a determination is made as to whether or not there are more frames to process. If so, control returns to block 210, the next frame is retrieved and processing continues as described above. It should be noted that a particular feature may appear in non-successive frames, i.e. a multiple intervals in a video file. In that case, the next frame may not he the next frame in the video file but rather the next frame in the video file that includes the identified feature or features. If, during block 216, a determination is made that there are no more frames to process, control proceeds to an “End Modify Video” block 219 in which process 200 is complete.

FIG. 4 is an example of a flowchart of a “Model Frames” process 250 that may implement aspects of the claimed subject matter. Like process 200 (FIG. 3), in this example, process 250 is associated with logic stored in conjunction with APRS 116 on CRSM 112 (FIG. 1) and executed on one or more processors (not shown) of CPU 104 of computing system 102. FIG. 4 is described using the modeling of a human face as an example although it should be understood that other types of features employ similar techniques.

Process 250 starts in a “Begin Model Frames” block 252 and proceeds immediately to a “Get First N Frames” block 254. During processing associated with block 254, a specified number of frames corresponding to a video file to be modified are retrieved, The specific number ‘N’ may be specified by means of a user defined parameter (see 156, FIG. 2) of calculated during processing to ensure a specified accuracy. As is known to those with skill in the relevant arts, the more frames that are employed during processing associated with blocks 254 and 256, i.e. the higher the value of ‘N’, the more accurate representation that can be generated. For example, to generate a 3D model from one (I) frame requires many assumptions about the shape of a particular feature. If frames showing a feature from multiple angles and perspectives are employed, fewer assumptions are necessary and a resulting 3D model is typically more accurate.

During processing associated with a “Get Frame” block 256, one of the frames selected during processing associated with block 254 is identified for processing. Typically, frames are processed in chronological order and, therefore during the first iteration through block 256, the first frame selected is the one that was captured earliest. During processing associated with an “Identify Elements” block 258, in this example, human thee presence and position is detected by running face detection algorithms, which are well known to those with sill in the relevant arts and are currently implemented even in consumer-level product such as photo cameras (see 144, FIG. 2). The information gathered is saved for later processing.

During processing associated with a “More Frames?” block 260, a determination is made as to whether or not all the frames identified during processing associated with block 254 have been processed. If not, processing returns to block 256, the next unprocessed frame is selected and processing continues as described above. If so, control proceeds to “Correlate Frame Elements” block 262. During processing associated with block 262, the instances of the elements identified during processing associated with block 258 are correlated from frame to frame (see 146, FIG. 2). For example, movement of a face between frames, corresponding to differences between instances of the thee in each frame, may be tracked by running feature-tracking algorithms, currently used for security monitoring in public areas.

During processing associated with a “Build and Save 3D Model” block 264. the elements identified during processing associated with block 258 and correlated during processing associated with block 262 are employed to generate a 3D model of the particular feature that is to be modified (see 148, FIG. 2). Face detection algorithms can map a specific face image to one of a given list of known faces, which is currently performed when searching investigation databases. 3D mesh reconstruction algorithms are run on one or more images, i.e. N images, to create a virtual 3D representation of the face. The feasibility of obtaining an accurate output from this kind of processing is helped by any preliminary information about the 3D model we are reconstructing, e.g., the feature is known to be a human head. A 3D model of the target is created inside the system which may include a 3D mesh and a color corresponding to each of the “pixels” of the surface. Color may he processed to detect shadow areas, e.g., a nose with lateral light will create a shadow on the face. The final model typically includes 3D structure, surface color and lighting information.

Once 3D modeling has been completed, the model is saved in models 152 (FIG. 2) for use in image modification (see 200, FIG. 3). Finally, control proceeds to an “End Model Frames” block 269, in which process 259 is complete.

FIG. 5 is one example of a video frame 300 shown on display 106 (FIG. 1) that may be analyzed and modified in accordance with the claimed subject matter. Display 106 includes a Start button 302 and an application button corresponding to a executing APRS process , or “APRS,” 304. Buttons such as buttons 302 and 304 will be familiar to those with experience in windows based graphical user interfaces (GUIs).

Frame 300 is displaying a character 306 with a face 308. An element ID box 312 is isolating one or more elements, which in the example are face 308 and hair 310 for analysis and modification in accordance with the claimed subject matter. As explained above in conjunction with FIGS. 3 and 4, during analysis of a frame such as frame 300, a 3D model of the selected element is generated. in accordance with current techniques, a 3D modeling grid 314 is generated for face 308 to facilitate the modeling process.

FIG. 6 is a modified video frame 320, based upon video frame 309 first introduced in FIG. 5, after modification in accordance with the claimed subject matter and displayed on display 106 (FIGS. 1 and 5). Like frame 300, frame 320 displays character 306 with face 308. Display 106 also includes buttons 302 and 304 (FIG. 5).

An element ID box 328 has selected particular elements for modification. In this example the color of hair 310 (FIG. 4) has been modified to produce hair 322 and glasses 324 have been added to face 308. It should be understood that hair 322 and glasses 324 are only two examples of features on face 308 that may be modified in accordance with the claimed subject matter. Other examples include, but are not limited to changing the size or shape of a feature such as a mouth or nose or adding or removing a feature such as a blemish or tattoo.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to he exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as arc suited to the particular use contemplated.

The flowchart and block diagrams in the Figures illustrate the architecture, functionality, and operation of possible implementations of systems, methods and computer program products according to various embodiments of the present invention. In this regard, each block, in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, he executed substantially concurrently, or the blocks may sometimes he executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

We claim:

1. A method, comprising:
processing a subset of a plurality of video frames to produce a 3D model of a particular element within each frame of the subset;
processing the plurality of video frames to identify a particular feature within the particular element in each frame of the plurality of frames in which the particular feature appears to produce a plurality of instances of the element, each instance of the plurality of instances associated with a corresponding frame of the plurality of frames;
modifying each instance of the plurality of instances in accordance with user-defined parameters and in conformity with the 3D model to generate a plurality of modified instances; and
replacing each instance of the plurality of instances With a corresponding modified instance in the corresponding frame of the plurality of frames to produce a modified video file,

2. The method of claim 1, wherein the processing of the subset of the plurality of video frames to produce a 3D model, comprises:
identifying an identifying feature in each frame of the subset of frames; and
tracking the identifying feature from frame to frame in the subset of frames to produce a correlation between the corresponding identifying feature in successive frames of the subset of frames.

3. The method of claim 1, where a specific number of frames in the subset is based upon a user-defined parameter.

4. The method of claim 1, wherein the feature. is a human face.

5. The method of claim 1, wherein the feature is an article of clothing.

6. The method of claim 1, further comprising rendering the modified video file on a display.

7. An apparatus, comprising:
a processor;
a computer-readable storage medium coupled to the processor; and
logic, stored on the computer-readable storage medium and executed on the processor, for:
processing as subset of a plurality of video frames to produce a 3D model of a particular clement within each frame of the subset;
processing the plurality of video frames to identify a particular feature within the particular element in each frame of the plurality of frames in which the particular feature appears to produce a plurality of instances of the element, each instance of the plurality of instances associated with a corresponding frame of the plurality of frames;
modifying each instance of the plurality of instances in accordance with user-defined parameters and in conformity with the 3D model to generate a plurality of modified instances; and
replacing each instance of the plurality of instances with a corresponding modified instance in the corresponding frame of the plurality of frames to produce a modified video file,

8. The apparatus of claim 7, wherein the logic for processing of the subset of the plurality of video frames to produce a 3D model, comprises logic for:
identifying an identifying feature in each frame of the subset of frames; and
tracking the identifying feature from frame to frame in the subset of frames to produce a correlation. between the corresponding identifying feature in successive frames of the subset of frames.

9. The apparatus of claim 7, where a specific number of frames in the subset is based upon a user-defined parameter.

10. The apparatus of claim 7, wherein the feature is a human thee.

11. The apparatus of claim 7, wherein the feature is an article of clothing.

12. The apparatus of claim 7, the logic further comprising logic for rendering the modified video file on a display.

13. A computer programming, product, comprising:
a computer-readable storage medium; and
logic, stored on the computer-readable storage medium for execution a processor, for:
processing a subset of a plurality of video frames to produce a 3D model of a particular element within each frame of the subset;
processing the plurality of video frames to identify a particular feature within the particular element in each frame of the plurality of frames in which the particular feature appears to produce a plurality of instances of the element, each instance of the plurality of instances associated with a corresponding frame of the plurality of frames;
modifying each instance of the plurality of instances in accordance with user-defined parameters and in conformity with the 3D model to generate a plurality of modified instances; and
replacing each instance of the plurality of instances with a corresponding modified instance in the corresponding frame of the plurality of frames to produce a modified video file.

14. The computer programming product of claim 13, wherein the logic for processing of the subset of the plurality of video frames to produce a 3D model, comprises logic for:
identifying an identifying feature in each frame of the subset of frames; and
tracking the identifying feature from frame to frame in the subset of frames to produce a correlation between file corresponding identifying feature in successive frames of the subset of frames.

15. The computer programming product of claim 13, where a specific number of frames in the subset is based upon a user-defined parameter.

16. The computer programming product of claim 13, wherein the feature is a human face.

17. The computer programming product of claim 13, wherein the feature is an article of clothing.

18. The computer programming product of claim. 13, the logic further comprising logic for rendering the modified video file on a display.

19. A video camera, comprising;
a processor;
a computer-readable storage medium coupled to the processor; and
logic, stored on the computer-readable storage medium and executed on the processor, for:
processing a subset of a plurality of video frames to produce a 3D model of a particular element within each frame of the subset;
processing the plurality of video frames to identify a particular feature within the particular element in each frame of the plurality of frames in which the particular feature appears to produce a plurality of instances of the element, each instance of the plurality of instances associated with a corresponding frame of the plurality of frames;
modifying each instance of the plurality of instances in accordance with user-defined parameters and in conformity, with the 3D model to generate a plurality of modified instances; and
replacing each instance of the plurality of instances with a corresponding modified instance in the corresponding frame of the plurality of frames to produce a modified video file.

20. The video camera of claim 19, wherein the logic for processing of the subset of the plurality of video frames to produce a 3D model, comprises logic for:
identifying an identifying feature in each frame of the subset of frames; and
tracking the identifying feature from frame to frame in the subset of frames to produce a correlation between the corresponding identifying feature in successive frames of the subset of frames.

21. The video camera of claim 19, where a specific number of frames in the subset is based upon a user-defined parameter.

22. The video camera of claim 19, wherein the feature is a human face.

23. The video camera of claim 19, wherein the feature is an article of clothing.

24. The video camera of claim 19, the logic further comprising logic for rendering the modified video file on a display.
